(19) United States
(12) Patent Application Publication
(10) Pub. No.: US 2011/0276711 A1
(43) Pub. Date: Nov. 10, 2011

(54) Multicast service discovery

(75) Inventors: Michelle Xiaohong Gong, Sunnyvale, CA (US); Guoqing Li, Portland, OR (US)

(73) Assignee: Intel Corporation

(21) Appl. No.: 12/800,165

(22) Filed: May 10, 2010

(51) Int. Cl. G06F 15/16; G06F 3/048

(52) U.S. Cl. 709/231; 715/810

(57) ABSTRACT

A sink device service discovery initiation procedure performed at the Protocol Adaptation Layer (PAL) is described.

### BACKGROUND

The demand for increasing data transfer rates between devices is ever increasing, and in particular, wireless data transfer rates. To meet the demand for increasing wireless data transfer rates, a new high-speed wireless standard WiGig is under development. WiGig facilitates communication between wireless communications systems operating in the 60 GHz band for devices such as computing, entertainment, and communications devices, including, televisions, stereos, personal digital assistants (PDA), mobile telephones, media playing devices, gaming devices, personal computers, laptop computers, and any another suitable wireless communication device. For example, WiGig products may transfer data in a range of approximately 1 Gigabits per second (Gbps) to 6 Gbps, within a range of less than 10 meters, i.e., within a single room.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a block diagram illustrating an environment of a communications network.

FIG. 2 is a block diagram illustrating an environment of a communications network comprising a relay station.

FIG. 3 is an illustration of a protocol stack employed in a communications network.

FIG. 4 is a flow diagram of a method of service discovery by a sink device of services provided by a source device.

FIG. 5 is an illustration of a PAL service request.

FIG. 6 is an illustration of a PAL service response.

FIG. 7 is an illustration of a stream configuration field of a PAL service response.

### DETAILED DESCRIPTION

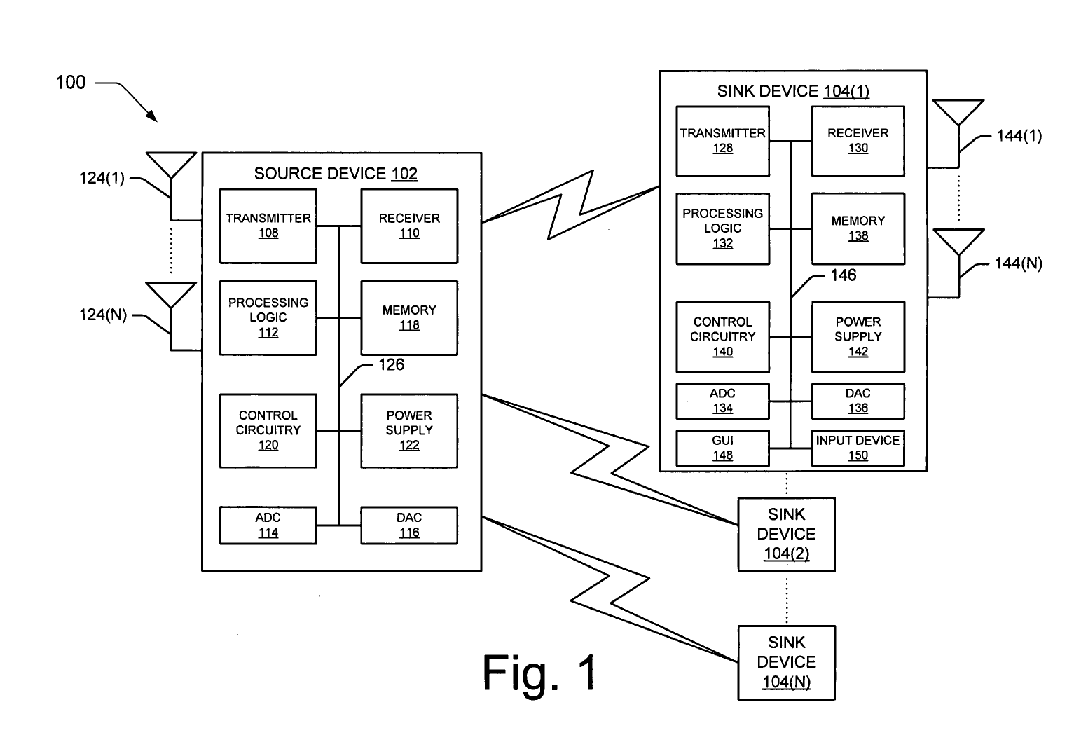

The present application describes a sink device service discovery initiation procedure performed at the Protocol Adaptation Layer (PAL). Many specific details are set forth in the following description and in FIGS. 1-7 to provide a thorough understanding of various implementations. One skilled in the art will understand, however, that the subject matter described herein may have additional implementations, or that the concepts set forth may be practiced without several of the details described in the following description.

### Communications System 100

FIG. 1 is a block diagram of a communication system 100. Communication system 100 includes a source device 102 and a plurality of sink devices 104(1), 104(2), . . . , 104(n). The communication system 100 may operate within the Wireless Gigabit Alliance WiGig standard. The sink device 104 performs a service discovery initiation procedure of services provided by the source device 102 at the Protocol Adaptation Layer (PAL).

### Source Device 102

The source device 102 includes a transmitter 108, a receiver 110, processing logic 112, an analog-to-digital converter (ADC) 114, a digital-to-analog converter (DAC) 116, a memory 118, control circuitry 120, a power supply 122, antenna(s) 124, and a bus 126. The source device 102 is configured to transmit to, and receive signals from, the sink devices 104. Specifically, the DAC 116 converts signals from digital to analog such that the transmitter 108 transmits wireless signals via the antenna(s) 124. The receiver 110 receives wireless signals via the antenna(s) 124 and converts the signals from analog to digital via the ADC 114. The wireless signals comprise audio, video, data, control information, or any combination thereof.

The processing logic 112 includes one or more processors and the memory 118 is accessible to the processing logic 112. The memory 118 includes read-only memory (ROM), random access memory (RAM), flash memory, a hard disk, or any combination thereof. Additionally, the memory 118 stores one or more applications configured to transmit and/or receive the wireless signals. The applications stored in the memory 118 may include software instructions, hardware, or any combination thereof. Additionally, the control circuitry 120 provides control signals to the components of the device 102. The device 102 may include a single antenna 124 or a plurality of antennas 124.

The source device 102 may be implemented in any number of ways, including but not limited to, a laptop computer, a desktop computer, a set top box, a media player, a DVD player, a CD player, a Blu-Ray player, a smart phone, a hand-held computing device (e.g., a personal digital assistant (PDA)), a mobile telephone, a gaming console, another suitable wireless communication device, any source of data that is able to transmit data wirelessly, or any combination thereof.

### Sink Device 104(1)

The sink device 104(1) is an exemplary representation of other sink devices, such as sink device 104(2) to 104(N). In this example, sink device 104(1) includes a transmitter 128, a receiver 130, processing logic 132, an analog-to-digital converter (ADC) 134, a digital-to-analog converter (DAC) 136, a memory 138, control circuitry 140, a power supply 142, antenna(s) 144, a bus 146, a graphical user interface 148, and an input device 150. The sink device 104(1) is configured to transmit to, and receive signals from the source device 102. Specifically, the DAC 136 converts signals from digital to analog such that the transmitter 128 transmits wireless signals via the antenna(s) 144. The receiver 130 receives wireless signals via the antenna(s) 144 and converts the signals from analog to digital via the ADC 134. The wireless signals comprise audio, video, data, control information, or any combination thereof.

The processing logic 132 includes one or more processors and the memory 138 is accessible to the processing logic 132. The memory 138 includes read-only memory (ROM), random access memory (RAM), flash memory, a hard disk, or any combination thereof. Additionally, the memory 138 stores one or more applications configured to transmit and/or receive the wireless signals. The applications stored in the memory 138 include software instructions, hardware, or any combination thereof. Additionally, the control circuitry 140 provides control signals to the components of the sink device 104(1). The sink device 104(1) includes a single antenna 144 or a plurality of antennas 144.

The graphical user interface 148 provides a display to a user of the sink device 104(1) such that the user can interact with the sink device 104(1). The interaction can include selection of items displayed on the graphical user interface 148 of the sink device 104(1), described further below. To provide interaction with sink device 104(1), the graphical user interface 148 includes a monitor or other source of visual display. Further, to enable the interaction with the graphical user interface 148, the input device 150 is employed. The input device 150 includes any device that provides selection of items displayed on the graphical user interface 148 of the sink device 104(1), such as a mouse or a keyboard.

The plurality of sink devices 104 may be implemented in any number of ways, including, but not limited to, a projector, a television, a monitor, a stereo, a media playing device, a smart phone, a hand-held computing device (e.g., a personal digital assistant (PDA)), an e-reader, a mobile telephone, a portable gaming device, a personal computer, a laptop computer, another suitable wireless communication device, or any combination thereof.

### Relay Station 200

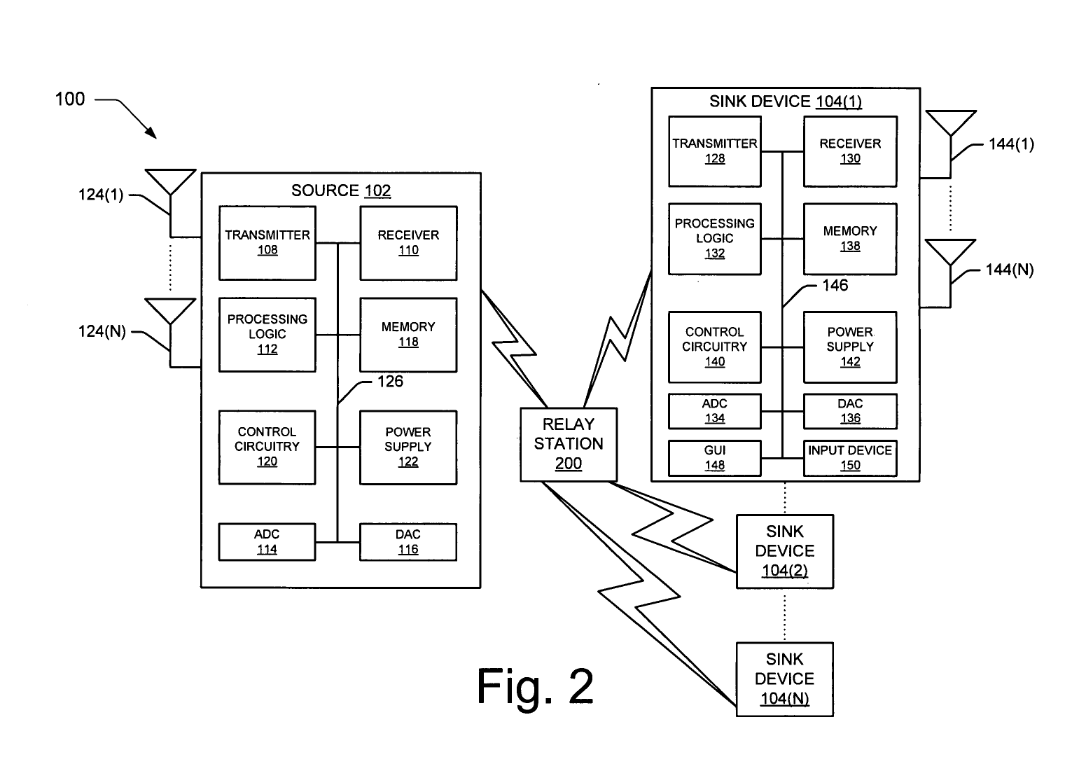

FIG. 2 shows the communication system 100 further comprising a relay station 200. Specifically, in a further implementation, the communication system 100 includes the relay station 200 to facilitate communication between the source device 102 and the sink devices 104. The relay station 200 facilitates transfer of signals such as video, audio, data, control information, or any combination thereof

### Protocol Stack 300

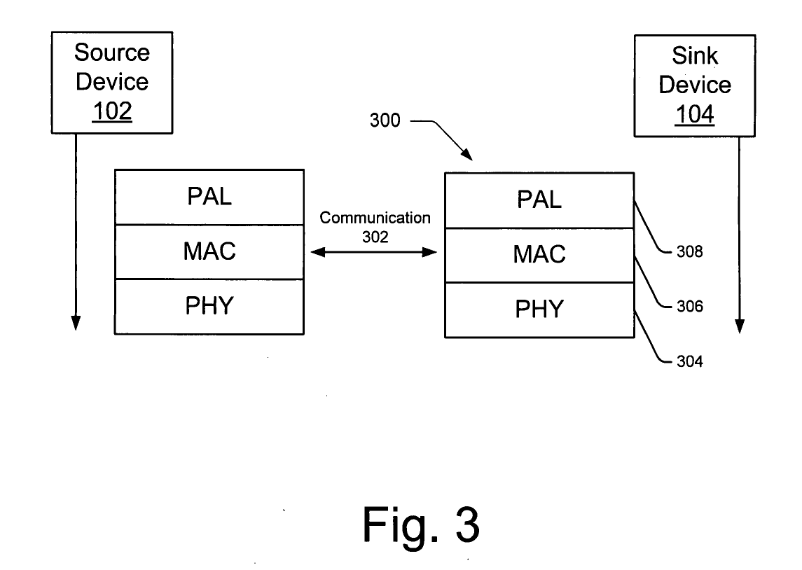

FIG. 3 shows a protocol stack 300 that is employed in communication 302 of data packets between the source device 102 and the sink device 104. In an example, the protocol stack 300 includes a physical (PHY) layer 304, a media access control (MAC) layer 306, and a protocol adaptation layer (PAL) layer 308. The protocol stack 300 may comprise further communication layers as desired by the specific implementation of communication system 100.

### Services Provided by the Source Device 102

The source device 102 is employed to provide at least one service via a routing scheme to which the sink device 104 joins a service group to stream at least one service. In a further implementation, the source device 102 provides a plurality of services via the routing scheme, and in still a further implementation, the plurality of services are a plurality of audio/video data streams.

In an implementation when the source device 102 provides the plurality of services via the routing scheme, the source device 102 can provide the plurality of services via multiple service groups. In an example, the source device 102 provides a first service stream to a first service group of the sink devices 104 and a second service stream to a second service group of the sink devices 104, the first and second service groups of the sink devices 104 can include differing subsets of the sink devices 104.

To join a desired service group of the source device 102, the sink device 104 queries the source device 102, and more specifically, queries the services provided by the source device 102. Thus, the sink device 102 initiates joining the desired service group of the source device 102. In a further implementation, the sink device 102 initiates joining multiple service groups of the source device 104. The sink device 104 queries the services provided by the source device 102, i.e. service discovery of the source device 102, utilizing the PAL layer 308.

### Service Discovery by the Sink Device 104

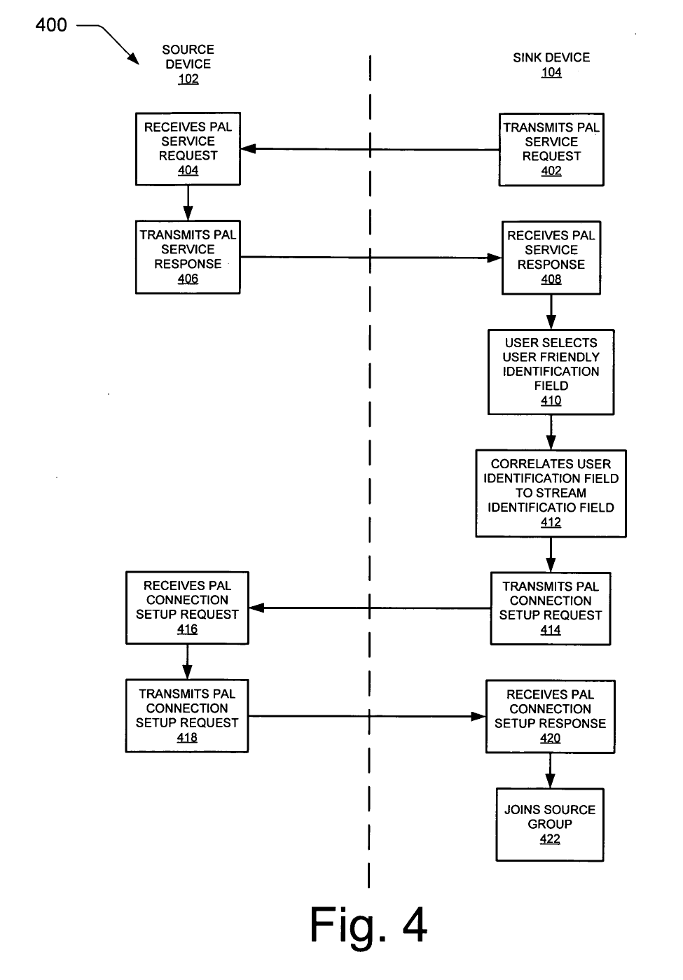

FIG. 4 shows a method 400 of service discovery by the sink device 104 of the services provided by the source device 102.

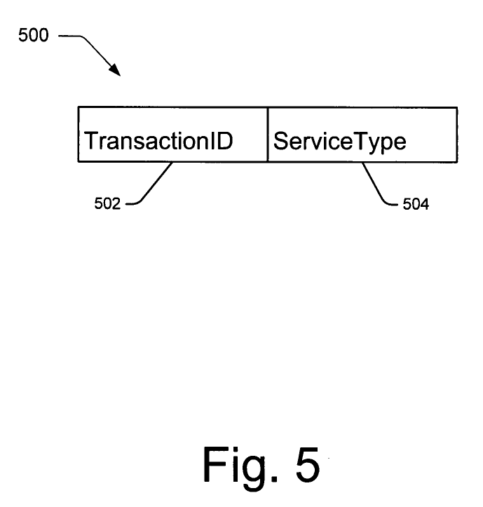

At step 402, the sink device 104 transmits a PAL service request to the source device 102 via the PAL layer 308. The PAL service request queries available services provided by the source device 102. FIG. 5 shows an example of a PAL service request 500. The PAL service request 500 includes a transaction identification field 502 and a service type field 504. The transaction identification field 502 identifies the specific transaction for the service query. The service type field 504 identifies the service type being requested. In an example, the service type is multicast, broadcast, or unicast; however, the service type may be any type dependent upon the specific implementation of communication system 100.

At step 404, the source device 102 receives the PAL service request.

At step 406, the source device 102 transmits a PAL service response to the sink device 104 via the PAL layer 308.

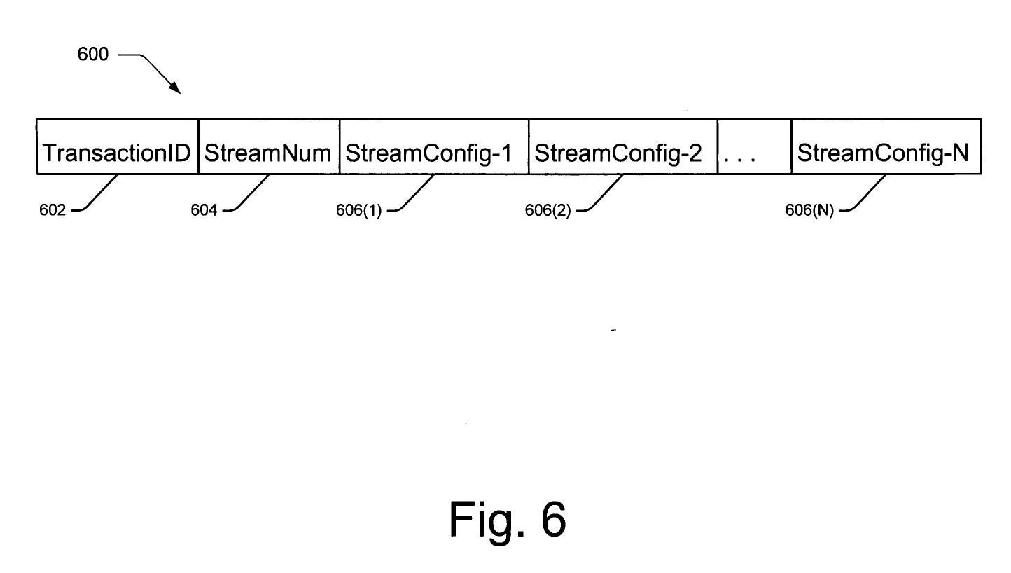

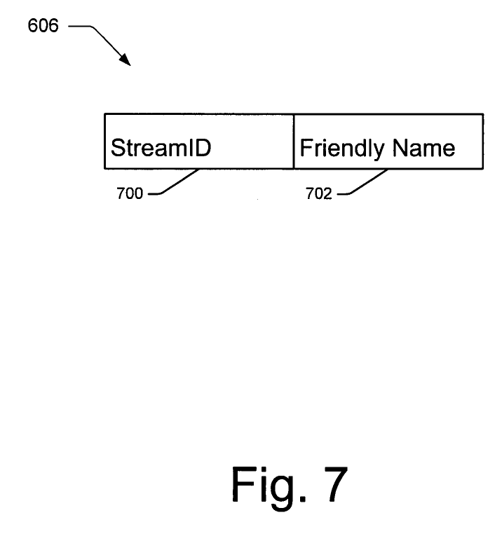

At step 408, the sink device 104 receives the PAL service response. The PAL service response indicates at least one available service of the source device 102. FIG. 6 shows an example of a PAL service response 600. The PAL service response 600 includes a transaction identification field 602, a stream number field 604, and stream configuration fields 606(1), . . . , 606(n). The transaction identification field 602 is analogous to the transaction identification field 602 and identifies the specific transaction for the service query. The stream number field 604 identifies the number of available services provided by source device 102, and thus, the number of stream configuration fields 606. The stream configuration fields 606 specify service information of each available service of the source device 102. FIG. 7 shows a further detailed view of the stream configuration field 606. The stream configuration field 606 includes a stream identification field 700 and a user friendly identification field 702. Stream identification field 700 indicates a PAL-level stream identity of the available service of source device 102. The user friendly identification field 702 indicates user-identifiable information, e.g. (“Tyler's Media Stream”), for presentation on the graphical user interface 148 for selection of the available service by a user of the sink device 104. The stream identification field 700 corresponds to the user friendly identification 702 for each available service provided by the source device 102. In a further implementation, the stream configuration field 606 includes additional fields for further detailed service information of the available service.

At step 410, a user of the sink device 104 selects the user friendly identification field 702 of a desired service of the plurality of available services provided by the source device 104.

At step 412, the sink device 104 correlates, i.e. maps, the selected user friendly identification field 702 with the corresponding stream identification field 700 of the selected available service.

At step 414, the sink device 104 transmits a PAL connection setup request to the source device 102 via the PAL layer 308.

At step 416, the source device 102 receives the PAL connection setup request. The PAL connection setup requests streaming of the available service of the source device 102 identified by the selected user friendly identified field 702 and the stream identification field 700 mapped thereto.

At step 418, the source device 102 transmits a PAL connection set up response to the sink device 104 via the PAL layer 308.

At step 420, the sink device 104 receives the PAL connection setup response. The PAL connection setup response indicates a status of success (or failure) of the sink device 104 joining the service group of the source device 102 that is providing the selected service identified by the selected user friendly identified field 702 and the stream identification field 700 mapped thereto. In a further implementation, the PAL connection set up response further includes reasons for the status, such as invalid group address or no resource available.

At step 422, the sink device 104 joins a service group of the source device 102 that is providing the selected service identified by the selected user friendly identified field 702 and the stream identification field 700 mapped thereto. In a further implementation, the service group of the source device 102 that is providing the selected service identified by the selected user friendly identified field 702 and the stream identification field 700 mapped thereto is an existing service group.

### CONCLUSION

Although embodiments of communication systems have been described in language specific to structural features and/or methods, it is to be understood that the subject of the appended claims is not necessarily limited to the specific features or methods described. Rather, the specific features and methods are disclosed as exemplary implementations for communication systems.

What is claimed is:

1. A method performed by a sink device comprising:
transmitting a service request to a source device to query available services provided by the source device;
receiving a service response indicating at least one available service of the source device, each available service being indicated by a stream identification and a corresponding user friendly identification;
selecting the user friendly identification associated with the at least one available service;
correlating the user friendly identification with the stream identification of the at least one available service; and
transmitting a connection setup request to the source device requesting streaming of the at least one available service identified by the stream identification.

2. The method as recited in claim 1 further comprising receiving a connection set up response indicating a status of success of joining a multicast group streaming the at least one available service.

3. The method as recited in 2 further includes joining the multicast group.

4. The method as recited in claim 2 wherein communication of the service request, the service response, the connection setup request, and the connection set up response is over a protocol adaptation layer (PAL).

5. The method as recited in claim 2 wherein joining the multicast group further includes joining an existing multicast group.

6. The method as recited in claim 1 wherein receiving the service response packet further comprising the service response packet indicating a plurality of available services.

7. The method as recited in claim 1 wherein receiving the service response packet further comprising the service response packet indicating a plurality of available audio/video data streams.

8. The method as recited in claim 1 wherein transmitting the service request packet is prior to receiving data from the source device.

9. The method as recited in claim 1 wherein transmitting the service request packet further includes the available services being provided via multicast, broadcast, or unicast.

10. A sink device comprising:
a processing unit;
a memory coupled to the processing unit;
a transmitter, coupled to the processing unit, to transmit a service request packet to query available services provided by a source device;
a receiver, coupled to the processing unit, to receive a service response packet indicating at least one available service of the source device, each available service being indicated by a stream identification and a corresponding user friendly identification; and
a graphical user interface for a user to select the user friendly identification associated with the at least one available service.

11. The sink device of claim 10 wherein the processing unit correlates the user friendly identification with the stream identification of the at least one available service.

12. The sink device of claim 10 wherein the transmitter further transmits a connection setup request packet to the source device requesting streaming of the at least one available service identified by the stream identification.

13. The sink device of claim 10 wherein the receiver further receives a connection set up response indicating a status of success of streaming of the at least one available service.

14. The sink device of claim 10 wherein communication of the service request packet, the service response packet, the connection setup request packet, and the connection set up response is over a protocol adaptation layer (PAL) of a packet communicated between the sink device and the source device.

15. The sink device of claim 10 wherein the receiver further receives the service response packet further comprising the service response packet indicating a plurality of available services.

16. The sink device of claim 10 wherein the receiver further receives the service response packet further comprising the service response packet indicating a plurality of available audio/video data streams.

17. A method performed by a sink device comprising:
transmitting a protocol adaptation layer (PAL) service request packet to a source device to query available audio/video data streams provided by the source device;
receiving a PAL service response packet indicating a plurality of available audio/video data streams of the source device, the PAL service response packet indicating the number of available audio/video data streams with each available audio/video data stream being indicated by a stream identification field and a corresponding user friendly identification field;
selecting the user friendly identification field associated with an audio/video data stream of the plurality of audio/video data streams;
correlating the user friendly identification field with the stream identification field of the selected audio/video data stream;
transmitting a PAL connection setup request packet to the source device requesting streaming of the audio/video data stream identified by selected stream identification field;
receiving a connection set up response indicating a status of success of joining a multicast group streaming the selected audio/video data stream; and
joining the multicast group.

18. The method as recited in claim 17 wherein transmitting the PAL service request packet is prior to receiving data from the source device.

19. The method as recited in claim 17 wherein transmitting the PAL service request packet further includes the available services being provided via multicast, broadcast, or unicast.

20. The method as recited in claim 17 wherein joining the multicast group further includes joining an existing multicast group.
